(19) United States
(12) Patent Application Publication
(10) Pub. No.: US 2008/0259606 A1
(43) Pub. Date: Oct. 23, 2008

(54) Light fixture for house number plates

(76) Inventor: Lung-Hsien Chen, Tainan County (TW)

Correspondence Address: Joe McKinney Muncy, PO Box 1364, Fairfax, VA, 22038-1364, US

(21) Appl. No.: 11/785,523

(22) Filed: Apr. 18, 2007

(51) Int. Cl. F21V 25/10; F21V 23/04

(52) U.S. Cl. 362/276; 362/394

(57) ABSTRACT

A light fixture for house number plates has a control circuit to automatically detect light in response the light intensity of sunshine to control timing of activation of the light fixture to illuminate a house number plate. It has a lamp which can be driven by electric power converted through a solar energy panel to meet environmental protection requirement. An overload protection circuit is provided to increase the life span of the light fixture. The light fixture is coupled with the house number plate to provide effective illumination and environmental protection.

### FIELD OF THE INVENTION

The present invention relates to a light fixture for house number plates and particularly to a lamp set that automatically sets ON or OFF in response to sunshine conditions.

### BACKGROUND OF THE INVENTION

The conventional light fixture for house number plates has a number of drawbacks when in use, notably:

1. Many conventional light fixtures are driven by electric power of a storage battery. When the electric power of the storage battery is exhausted, the light fixtures become ineffective.

2. The conventional light fixture for door plates is easily turned on by inadvertent operation of users. If such an event happened during day time when no lighting is needed, the electric power of the storage battery is consumed unnecessarily, and the light fixture could be burned out sooner.

3. The electric power of the storage battery fluctuates according to use conditions. The lamp set used on the house number plate is at a low voltage. An excessive high voltage could result in burn out of the light fixture.

### SUMMARY OF THE INVENTION

The primary object of the present invention is to provide a light fixture for house number plates that can automatically set ON or OFF in response to sunshine conditions.

The light fixture of the invention includes at least a house number plate, a lamp set, a control system, a power section and a fastening element. The lamp set is installed around the house number plate and consists of a lamp shade and a lamp. The lamp shade aims to fix the lamp set to the house number plate. The lamp aims to evenly illuminate the house number plate. The control system is connected externally to the lamp set and includes an overload protection circuit, a photosensitive resistor circuit and a time control circuit to control utilization of the lamp. The power section is connected externally to the control system to provide power for the lamp set and the control system. The above elements are coupled with the house plate to become the light fixture of the invention.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of implementation flow of the invention.

FIG. 2 is an exploded view of the invention.

FIG. 3A is a perspective view of the invention.

FIG. 3B is a sectional view of the invention.

FIG. 4A is a schematic view of the invention coupling with another embodiment of the lamp.

FIG. 4B is a sectional view of the invention coupling with another embodiment of the lamp.

FIG. 5 is an exploded view of another embodiment of the invention.

FIG. 6 is a perspective view of another embodiment of the invention.

### DETAILED DESCRIPTION OF THE PREFERRED EMBODIMENTS

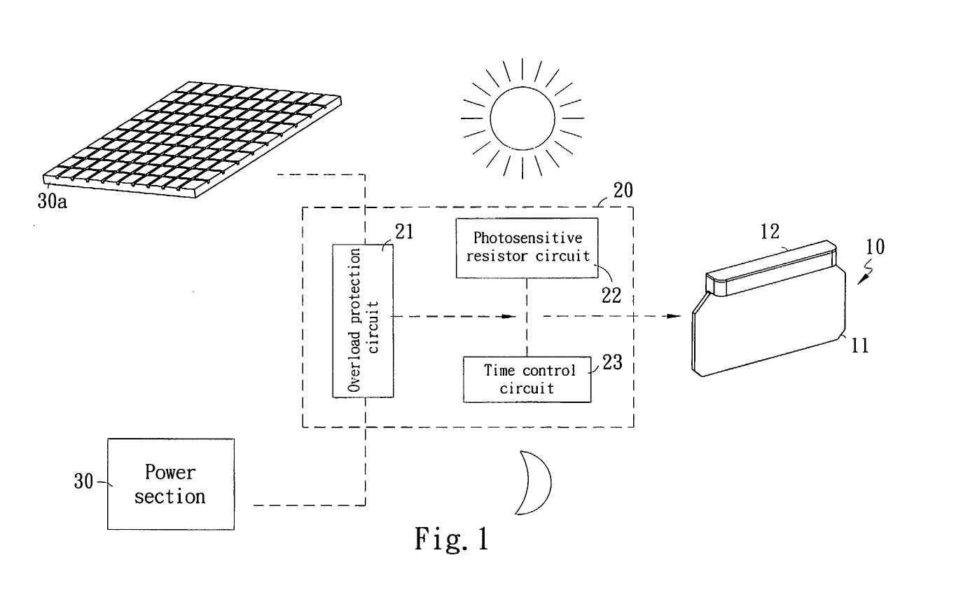

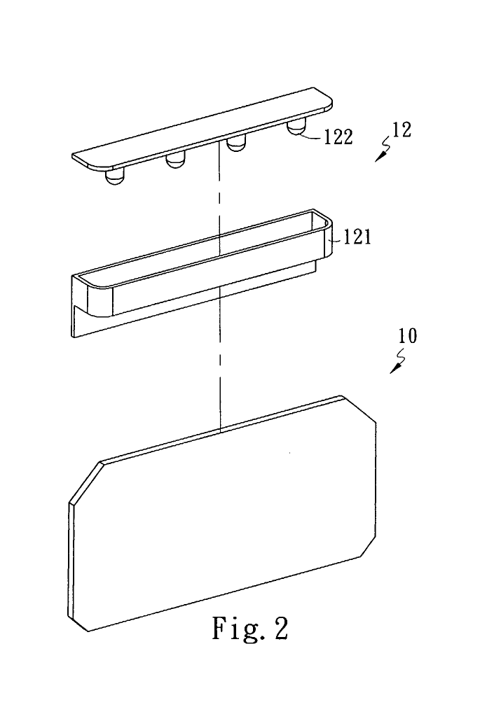

Please refer to FIGS. 1, 2 and 3A, the light fixture 10 for house number plates of the invention mainly includes a house number plate 11, a lamp set 12, a control system 20 and a power section 30. The lamp set 12 is located around the house number plate 11 to evenly illuminate the house number plate 11. The lamp set 12 includes a lamp shade 121 and a lamp 122 which projects light evenly on the house number plate 11 for easy recognition. The lamp set 12 is externally connected to the control system 20. The control system 20 mainly includes an overload protection circuit 21, a photosensitive resistor circuit 22 and a time control circuit 23. The overload protection circuit 21 aims to stabilize the power of the light fixture 10 when the power section 30 is unstable. The photosensitive resistor circuit 22 aims to activate the light fixture 10 according to the light intensity of sunshine. The time control circuit 23 aims to set use time. The power section 30 is externally connected to the control system 20 to provide power source to drive the lamp 122 and the control system 20. The power section can be city power used in the general houses or a storage battery. The light fixture 10 may also be driven by electric power converted by a solar energy panel 30a.

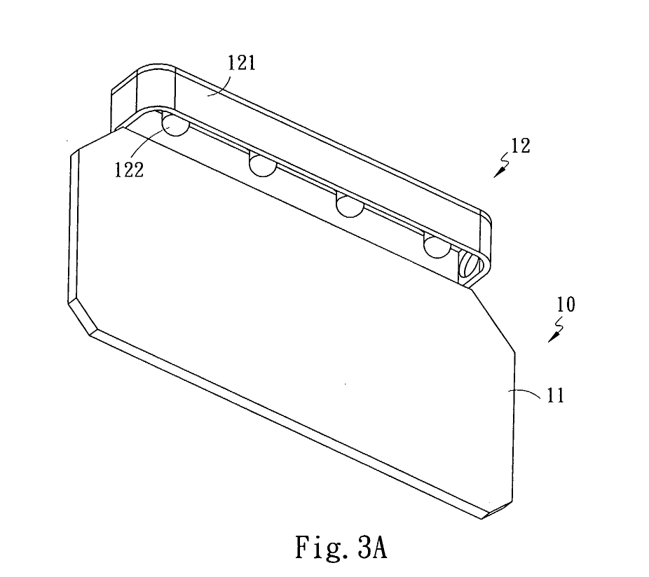

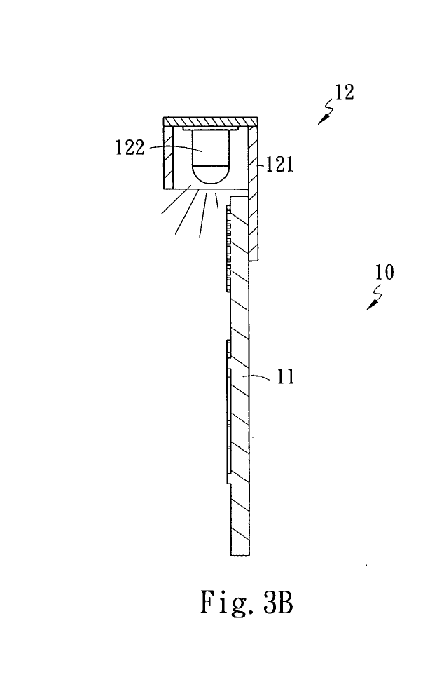

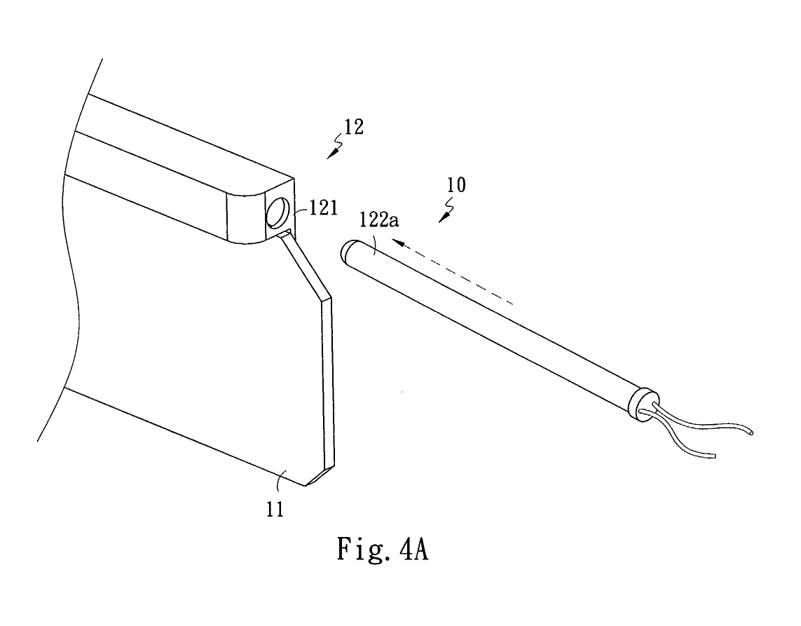

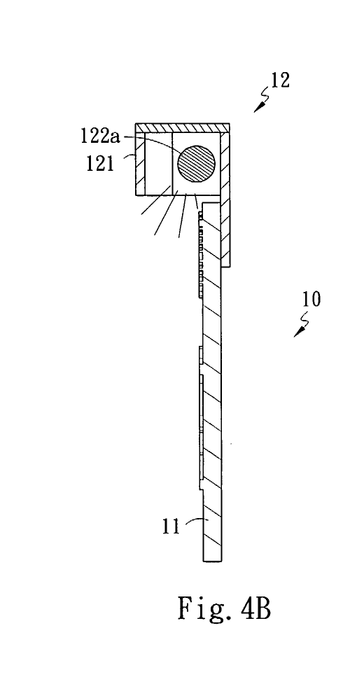

Refer to FIG. 3B, the lamp set 12 is located around the house number plate 11 to evenly illuminate the house number plate 11. It is preferably located at an upper end of the house number plate 11. But this is not the limitation of the invention. The lamp 122 may also be a high efficiency lamp such as LED, a cold cathode lamp 122a (such as the one shown in FIGS. 4A and 4B) or the like to save energy.

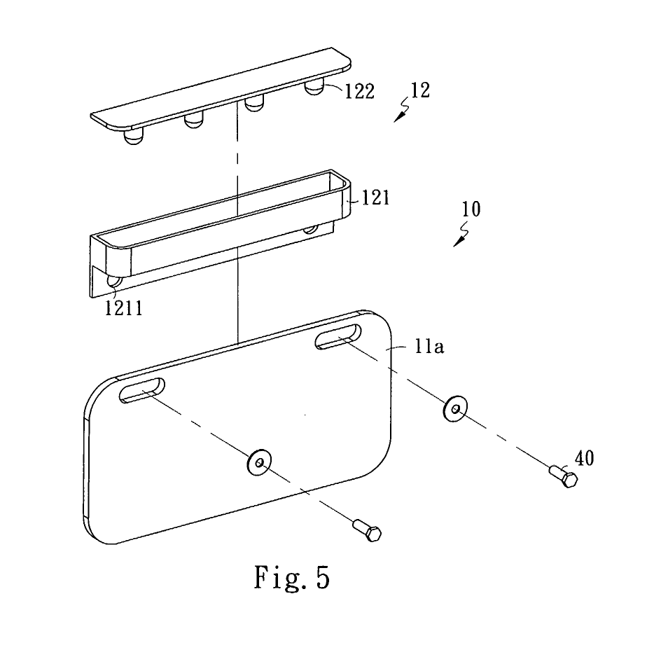

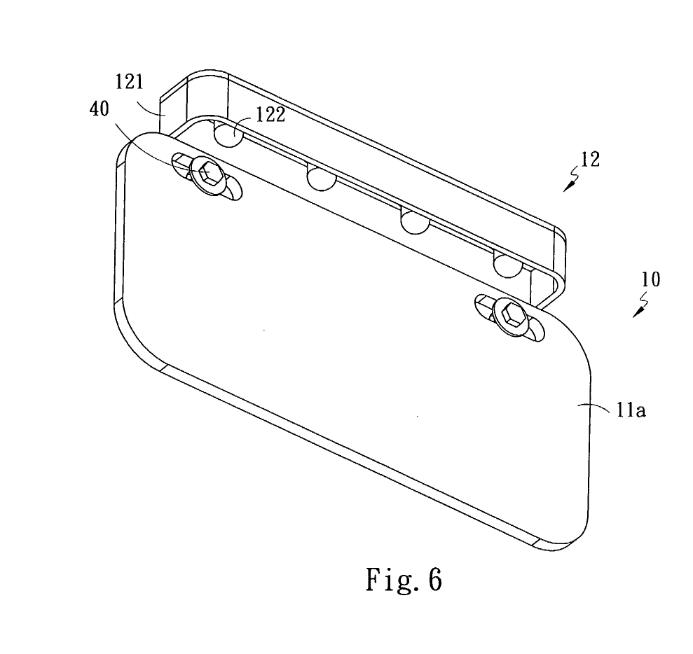

Refer to FIGS. 5 and 6 for another embodiment of the light fixture 10 of the invention. The light fixture 10 of the invention may also be used on a vehicle number plate 11a. The lamp set 12 is installed around the vehicle number plate 11a to evenly illuminate the vehicle number plate 11a. The lamp shade 121 has a through hole 1211 to receive a fastening element 40 to fix the lamp set 12 on the vehicle number plate 11a. The lamp 122 can evenly illuminate the vehicle number plate 11a to facilitate recognition.

Compared with the conventional light fixture for house number plates, the light fixture 10 of the invention has the following benefits:

1. The conventional light fixture for house number plates mostly uses the electric power of the storage battery. It becomes a burden to the power system of the storage battery. The light fixture 10 of the invention can use energy converted and collected by the solar energy panel 30a. Such an approach, in cooperation with the photosensitive resistor circuit 22, can utilize the solar energy collected by the solar energy panel 30a while the sunshine is available and turn off the light fixture 10. At night when the sunshine is not available the light fixture 10 of the invention is turned on, and the energy collected by the solar energy panel 30a can be used. Thus there is no extra burden to the storage battery. The electric power may also be stored for backup.

2. The conventional light fixture for house number plates tends to be inadvertently activated unnecessary, such as during day time. The light fixture 10 of the invention has the photosensitive resistor circuit 22 to detect the sunshine intensity of sunshine and determine whether the light fixture 10 has to be set ON or OFF. The control system 20 of the invention also has the time control circuit 23 to set the light fixture 10 ON or OFF according to user requirements. Thus electric power can be saved and the life span of the light fixture 10 increases.

3. The output electric power of the conventional storage battery generally fluctuates according to use conditions. The conventional light fixtures for house number plates mostly use a lower voltage. An excessive high voltage could result in burn out of the lamp. The control system 20 of the invention has the overload protection circuit 21 to protect the voltage of the supplying power for the light fixture 10, and also protect the power section 30 from an excessive low voltage in a reverse condition. Hence the power section 30 does not output power in the lower voltage condition for a prolonged period of time, and is less likely to be damaged.

What is claimed is:

1. A light fixture for house number plates, comprising at least:
a house number plate;
a lamp set including a lamp shade and a lamp and being installed around the house number plate to evenly illuminate the house number plate;
a control system which is externally connected to the lamp set to control use of the lamp and includes a overload protection circuit, a photosensitive resistor circuit and a time control circuit; and
a power section which is externally connected to the control system to provide power for the lamp set and operation of the control system;
wherein the overload protection circuit protects the lamp set and increases the life span thereof, the photosensitive resistor circuit detects the intensity of sunshine in the ambience to determine whether to set the light fixture ON or OFF, and the time control circuit sets ON or OFF time of the light fixture.

2. The light fixture of claim 1, wherein the lamp is an LED lamp which saves electric power.

3. The light fixture of claim 1, wherein the lamp is a cold cathode lamp which saves electric power.

4. The light fixture of claim 1, wherein the power section is city power used in households.

5. The light fixture of claim 1, wherein the power section is a storage battery.

6. The light fixture of claim 1, wherein the power section provides electric power through a solar energy panel which receives and converts solar energy.
